(19) United States
(12) Patent Application Publication
(10) Pub. No.: US 2024/0301320 A1
(43) Pub. Date: Sep. 12, 2024

(54) REMOVAL OF ORGANIC CHLORIDES FROM RENEWABLE FEEDSTOCKS

(71) Applicant: BP CORPORATION NORTH AMERICA, INC., Houston, TX (US)

(72) Inventors: Velu Subramani, Naperville, IL (US); Zhaorong Zhang, Naperville, IL (US); Zhuoran Xu, Lisle, IL (US); Renzy Lewis Stepp, Gilberts, IL (US); Robert Cherian Abraham, Bolingbrook, IL (US); Vincent Kispersky, Lisle, IL (US); Kevin Thacker, Valparaiso, IN (US); John Shabaker, Naperville, IL (US)

(21) Appl. No.: 18/573,647

(22) PCT Filed: Jun. 29, 2022
(86) PCT No.: PCT/US2022/035458

§ 371 Date: Dec. 22, 2023

Related U.S. Application Data
(60) Provisional application No. 63/216,882, filed on Jun. 30, 2021.

(51) Int. Cl. C11C 1/08; B01D 15/08

(52) U.S. Cl. CPC C11C 1/08; B01D 15/08

(57) ABSTRACT

The present disclosure related generally to a process for removing chloride-containing organic compounds from renewable and bio-feedstocks. Accordingly, in one aspect, the present disclosure provides for a process for processing a liquid feed, the process comprising: providing a liquid feed that comprises one or more fatty acids and/or fatty acid esters, the liquid feed having a first chloride concentration by weight of chloride-containing organic compounds; and contacting the liquid feed with a solid treatment material to remove at least a fraction of the chloride-containing organic compounds to produce a treated liquid feed having a second chloride concentration that is less than the first chloride concentration, wherein the solid treatment material comprises an alkali metal or an alkaline earth metal in ionic form.

### FIELD

The present disclosure relates generally to processes for reducing the concentration of chloride-containing organic compounds in renewable feedstocks.

### TECHNICAL BACKGROUND

Using renewable feedstocks (such as bio-feedstocks) to manufacture renewable diesel, biodiesel, bio-jet, and other transportation fuels is becoming an attractive option to mitigate environmental emissions and to decrease energy dependence on fossil fuels. Some of the renewable feedstocks considered for producing renewable diesel and biodiesel include fats, oil, and greases (collectively, FOGs), which are more typically industrially used for food, feed, oleochemicals, and fatty acid methyl ester (FAME) production. Renewable feedstocks sourced from FOGs are beneficial as they can produce diesel range paraffins when hydroprocessed. As the person of ordinary skill in the art will appreciate, hydroprocessing refers to the treatment of a feedstock with hydrogen in the presence of a suitable catalyst. The general term “hydroprocessing” encompasses, among others, a number of transformations, including hydrodesulfurization, hydrodenitrogenation, hydrodemetallization, hydrodeoxygenation, hydrodecarboxylation, hydrodecarbonylation, hydrogenation of olefins and aromatics, and hydrocracking. Renewable feedstocks can be, for example, co-processed along with crude oil-derived streams to provide a product that is derived from a combination of fossil fuel and renewable feedstock, or instead can be processed as a sole feedstock (100%) in a dedicated processing unit to provide a material derived solely from a renewable feedstock.

Before hydroprocessing, an initial step in making renewable feedstocks, such as bio-feedstocks, viable for fuel production is to reduce the amount of certain contaminants. Depending on the source and any processing and transporting of the feedstock, renewable feedstocks can contain a variety of contaminants including phosphorous, metals, chlorides, particulates, plastics, etc., in varying amounts. Contaminants can, for example, be poisonous to catalysts used in fuel refining units as well as damaging to fuel refining equipment, impacting the reliability, efficiency, and longevity of the fuel refining process. These concerns result in the potential for increased cost of a final product. Accordingly, to reduce the degree of such contaminants, pre-treatment of the renewable feedstock is often employed before hydroprocessing. Examples of pre-treatment processes include degumming, bleaching, water washing, and filtration.

One class of contaminants that can be especially damaging to the fuel refining process is chloride-containing inorganic and organic compounds. During hydroprocessing of renewable feedstocks containing such contaminants, hydrochloric acid is generated. Hydrochloric acid is highly corrosive and can cause severe damage to processing equipment, reducing its lifetime and thus increasing overall capital costs for a process. While these pretreatment steps can be effective at removing a majority of chloride-containing inorganic compounds and water-soluble chlorides, they are generally less effective at removing chloride-containing organic molecules, especially ones with lower water solubility. Even trace amounts of contaminants can be undesirable in the refining process. Often, even after pretreatment of the feedstock by the methods above, chloride-containing organic compounds will still be present in amounts in excess of 5 ppmw of chlorine, often up to 30 ppmw or even more. The presence of chloride-containing organic compounds within this range is still undesirably high for safe, efficient, and reliable hydroprocessing and downstream processes.

Currently, the generally available process to mitigate the harmful effects of chloride-containing organic compounds is dilution, e.g., with feedstocks that do not contain such contaminants. However, dilution limits the amount of renewable feedstocks that can be included in processed material, and increases the cost and time for processing of renewable feedstocks, limiting their viability as an alternative source for fuel production. Other processes reported in the literature to remove chloride-containing organic compounds from renewable feedstocks include electric desalting, use of chemical additives, and caustic treatment. These methods are not effective or efficient for chloride-containing organic compound removal as they can generate rag layers and can form soap, making the separation of the oil and aqueous phase much more tedious.

The composition of renewable feedstocks is often very different from that of fossil-derived crude oil. Such crude oil typically consists almost exclusively of hydrocarbons, typically a major proportion of paraffins, with some degree of polycyclic aromatics depending on the source. Renewable feedstocks, in contrast, are often highly oxygenated. For example, the so-called FOGs—fats, oils and greases—are typically fatty acid esters, specifically, of glycerin, e.g., chiefly in the form of triglycerides. Hydrolysis products are often present, too, e.g., diglycerides, monoglycerides and even fatty acids. The so-called FAME materials are chiefly methyl esters of fatty acids derived by methanolysis of FOGs. The sources of such materials are living or recently dead animals and plants—very different than the fossil deposits that are the basis of crude oil-based feedstocks. Accordingly, there can be no expectation that the contaminants are similar between crude oil-derived feedstocks and such renewable feedstocks, or that decontamination methods developed for crude oil-derived feedstocks may be successful adapted for renewable feedstocks.

Accordingly, there is a distinct need to develop robust processes for reducing the amount of chloride-containing organic compounds in renewable and bio-feedstocks that enable safe, efficient, and reliable hydroprocessing and fuel production.

### SUMMARY

As described in detail herein, the present inventors have found an efficient process for reducing the amount of chloride-containing organic compounds in renewable feedstocks through contacting a feedstock with a solid treatment material comprising an alkali metal or alkali earth metal in ionic form. Using this process, the inventors have found that the concentration of chloride-containing organic compounds can be significantly reduced in a renewable feedstock, for example, such that the treated feedstock has no more than 5 ppmw chlorine, e.g., no more than 2 ppmw chlorine.

Thus, in one aspect, the disclosure provides a process for processing a liquid feed. Such process includes:
providing a liquid feed that comprises one or more fatty acids and/or fatty acid esters, the liquid feed having one or more chloride-containing organic compounds and a first chloride concentration; and
contacting the liquid feed with a solid treatment material to reduce the amount of the one or more chloride-containing organic compounds to produce a treated liquid feed having a second chloride concentration that is less than the first chloride concentration,
wherein the solid treatment material comprises an alkali metal or an alkaline earth metal in ionic form.

The inventors have found that the process of the disclosure can be applied to a variety of liquid feeds that include one or more fatty acids and/or fatty acid esters. In certain embodiments, the liquid feed may be a renewable feedstock, such as a bio-feedstock.

Other aspects of the disclosure will be apparent to those skilled in the art in view of the description that follows.

### BRIEF DESCRIPTION OF FIGURES

FIG. 1. is a bar graph illustrating representative results of a process according to embodiments described in the Examples.

### DETAILED DESCRIPTION

The present disclosure is concerned with processes for removing chloride-containing organic compounds from liquid feeds, e.g. renewable feedstocks, such as bio-feedstocks, including one or more fatty acids and/or fatty acid esters. As described above, when chloride-containing organic compounds are hydroprocessed, hydrogen chloride is produced. This highly corrosive acid is dangerous and damaging to refinery equipment, leading to unreliable and inefficient production and unsafe conditions.

The present inventors have found a process to reduce the amount of chloride-containing organic compounds in renewable feedstocks including one or more fatty acids and/or fatty acid esters by contacting the feedstock with a solid treatment material comprising an alkali metal or alkaline earth metal in ionic form. Subsequent removal of the treated feedstock from the solid treatment material effectively removes the chloride-containing organic compounds from the liquid feed. Indeed, the concentration of the chloride-containing organic compounds can be significantly reduced using such a process, allowing the provision of treated feedstocks with no more than 5 ppmw chloride, e.g., no more than 2 ppmw chloride. In contrast to electric desalting and other treatments, the use of a solid treatment material comprising an alkali metal or alkaline earth metal in ionic form provides an efficient, effective, and easily implemented process to reduce amounts of chloride-containing organic compounds in renewable feedstocks containing one or more fatty acids and/or fatty acid esters.

Accordingly, one aspect of the disclosure provides a process for processing a liquid feed. Such a process includes:
providing a liquid feed that comprises one or more fatty acids and/or fatty acid esters, the liquid feed having a first chloride concentration; and
contacting the liquid feed with a solid treatment material to reduce the amount of the one or more chloride-containing organic compounds to produce a treated liquid feed having a second chloride concentration that is less than the first chloride concentration,
wherein the solid treatment material comprises an alkali metal or an alkaline earth metal in ionic form.

A variety of liquid feeds can be used in the processes described herein. As described above, the liquid feed includes one or more fatty acids and/or fatty acid esters. As used herein, a fatty acid is a C5-C24 alkylcarboxylate or alkenylcarboxylate. The person of ordinary skill in the art will appreciate that a given renewable feedstock source will typically dictate the distribution of fatty acyl moieties in the feedstock. In certain embodiments as otherwise described herein, the liquid feed includes at least 25 wt % fatty acids and/or fatty acid esters, e.g., at least 35 wt %. In certain embodiments as otherwise described herein, the liquid feed includes at least 40 wt % fatty acids and/or fatty acid esters, e.g., at least 60 wt %. In certain embodiments as otherwise described herein, the liquid feed includes at least 70 wt % fatty acids and/or fatty acid esters, e.g., at least 80 wt %, or at least 90 wt %. A variety of fatty acids and fatty acid esters are suitable for use in the processes described herein. For example, in certain embodiments the fatty acid ester includes one or more of fatty acid triglycerides, fatty acid diglycerides and fatty acid monoglycerides. Animal fats and vegetable oils, for example, are largely triglycerides, although when processed they can be partially broken down to include diglycerides and monoglycerides. In certain embodiments the fatty acid ester includes one or more fatty acid alkyl esters such as fatty acid methyl ester (e.g., the FAME material mentioned above) and fatty acid ethyl ester.

The proportion between fatty acid and fatty acid esters in the liquid feed can vary. For example, in various embodiments, the ratio of fatty acids to fatty acid esters can range from 0:1 to 1:0. In certain embodiments, the ratio of fatty acids to fatty acid esters is in the range of 0:1 to 1:1, e.g., from 0:1 to 1:0.5, or from 0:1 to 1:0.2, or from 0:1 to 1:0.1, or 0:1 to 1:0.05. The relative amount of fatty acid present can depend on a number of factors, including for example the degree of processing of a feedstock before the treatment described herein.

The person of ordinary skill in the art will appreciate that the one or more fatty acids and/or fatty acid esters will typically be provided by a renewable feedstock. In certain embodiments, substantially all of the liquid feed is a renewable feedstock. However, in other embodiments, the liquid feed can also include materials derived from other sources, e.g., crude oil. For example, it can be desirable in some circumstances to co-process a fatty acid and/or fatty acid ester-containing renewable material with a crude-oil derived material.

A variety of renewable feedstocks are known in the art. For example, in certain embodiments of the disclosure, a renewable feedstock used in the process is one or more of fats, oils, and greases (FOGs). In certain embodiments as otherwise described herein, the renewable feedstock may be one or more of animal fats and vegetable oils. Suitable non-limiting examples of animal fats include chicken fat, beef fat, pork fat, sheep fat and fish oil, e.g., in the form of choice white grease and inedible tallow. Suitable non-limiting examples of vegetable oils include corn oil, rapeseed (canola) oil, sunflower oil, soybean oil, cotton seed oil, nettlespurge oil, coconut oil and palm oil. As the person of ordinary skill in the art will appreciate, the fatty acid residue distribution will vary with the source and the prior treatment of the oil. Many naturally-derived oils are have chiefly one or more oleic acid, linoleic acid, palmitic acid and stearic acid as fatty acid residues. The renewable feedstock can advantageously be in the form of a used, recycled, or waste fat, oil or grease, e.g., in the form of used cooking oil; such materials often suffer from a higher and/or unpredictable degree of contaminants. Of course, other feedstocks are possible. For example, a fatty acid methyl ester (FAME) feedstock can be used. FAME feedstocks are typically derived from the methanolysis of triglycerides.

As described above, the liquid feed includes one or more chloride-containing organic compounds (i.e., one or more thereof) and has a first chloride concentration. As described above, chloride-containing organic compounds are undesirable contaminants, and can be substantially reduced in concentration using the processes described herein. The identity of the chloride-containing organic compounds will depend on the feedstock and its history. In certain embodiments the one or more chloride-containing organic compounds are one or more of chlorine-substituted long chain (C10+) paraffins, long-chain acid chlorides, chlorine-substituted long-chain aldehydes, chlorine-substituted long-chain ketones, cholesterol-like organic chlorides, chlorine-substituted long-chain diols, and chlorine-substituted short-chain (C2-C9) diols. For example, in certain embodiments a chloride-containing organic compound is a monochlorinated propanediol such as 3-monochloropropane-1,2-diol or 2-monochloropropane-1,3-diol.

Chloride-containing organic compounds may be naturally occurring or formed during processing of renewable feedstocks. For example, palm oil contains 3-monochloropropanediol (3-MPCD) as the primary chloride-containing organic compound. However, other compounds such as chloride-substituted long-chain (C10+) paraffins, long-chain acid chloride, chlorine-substituted long-chain aldehydes and ketones, and cholesterol-like organic chlorides may also be present in a renewable feedstock. Examples include fatty acid chlorides such as palmitoyl chloride, 9,12-octadecadienoyl chloride, stearoyl chloride and oleoyl chloride, vicinal hydroxy-chloro-fatty acids such as 9-chloro-10-hydroxyhexadecanoic acid, 10-chloro-9-hydroxyhexadecanoic acid, 9-chloro-10-hydroxyoctadecanoic acid, 10-chloro-9-hydroxyoctadecanoic acid, 11-chloro-12-hydroxyoctadecanoic acid, 12-chloro-11-hydroxyoctadecanoic acid; vicinal dichloro-fatty acids such as 9,10-dichlorooctadecanoic acid, 7,8-dichlorohexadecanoic acid, 5,6-dichlorotetradecanoic acid and 3,4-dichlorotridecanoic acid; and 2-chloro-fatty acids such as 2-chlorohexadecanoic acid, 2-chlorooctadecanoic acid, and 2-chloro-9-octadecenoic acid. Thus, the contaminants are rather different in these feedstocks as compared to the chlorinated compounds in crude oil, which are largely chloroform, carbon tetrachloride, mono-, tri- and tetra-chloroethylene, chlorobenzene, trichloroethane, dichloromethane, dichloropropene and chloroprene.

Based on the disclosure herein, the amount of chloride-containing compounds initially in the liquid feed, i.e., as measured by the first chloride concentration, is based on the source of the liquid feed and how the liquid feed has previously been used, processed and transported. For example, in certain embodiments, the first chloride concentration is at least 2 ppmw, e.g., at least 5 ppmw, or at least 7 ppmw, or at least 10 ppmw, or at least 15 ppmw. Of course, real-world sources often have only intermediate amounts of chloride-containing organics. For example, in certain embodiments, the first chloride concentration is no more than 300 ppmw, e.g., no more than 250 ppmw, or no more than 100 ppmw, or no more than 75 ppmw. In certain embodiments, the first chloride concentration is in the range of 2-300 ppmw, e.g., 5-300 ppmw, or 10-300 ppmw, or 2-100 ppmw, or 5-100 ppmw, or 10-100 ppmw. Chloride concentrations as described herein are measured by monochromatic wavelength dispersive X-ray fluorescence (MWDXRF), as determined by a Clora chlorine analyzer, available from XOS USA.

Of course, the liquid feed may contain other contaminants, depending on feedstock source and history. Examples of such contaminants include phosphates, metals, particulates, plastics, nitrogen-containing compounds and inorganic halides. These can be removed, as necessary or desired, using conventional methods.

The present inventors have determined that solid treatment materials containing an alkali or an alkaline earth in ionic form can be especially useful in the reduction of the amount of chlorinated organics from fatty acid and/or fatty acid ester-containing feedstocks. The solid treatment materials described herein can be used alone or in combination.

In certain embodiments as otherwise described herein, the solid treatment material comprises the alkali metal in ionic form. Examples of suitable alkali metal ions include lithium ions, sodium ions and potassium ions. For example, in certain embodiments the alkali or alkaline earth metals in ionic form include (or are) sodium ions. In other embodiments, the alkali or alkaline earth metals in ionic form include (or are) potassium ions. In other embodiments, the alkali or alkaline earth metals in ionic form are a combination of sodium and potassium ions. In other embodiments, the alkali or alkaline earth metals in ionic form include (or are) cesium ions.

In certain embodiments as otherwise described herein, the solid treatment material comprises the alkaline earth metal in ionic form. Examples of suitable alkaline earth metal ions include magnesium ions, calcium ions, strontium ions and barium ions. For example, in certain embodiments the alkaline earth metals in ionic form are magnesium ions. In other embodiments, the alkaline earth metals in ionic form are calcium ions. In certain embodiments, the alkaline earth metal in ionic form includes calcium and magnesium ions.

In certain embodiments the solid treatment material includes the alkali or alkaline earth metal ions disposed on (e.g., dispersed in or on) a support. For example, in certain embodiments, the support is alumina. In other embodiments, the support is an aluminosilicate, or a silicate. Notably, however, that the present inventors have determined that use of a zeolite is not necessary. Accordingly, in certain embodiments, the solid treatment material is not a zeolite.

For example, the present inventors have determined that alkali-doped alumina is an especially suitable solid treatment material from the standpoint of effectiveness and cost. For example, in certain embodiments, the alkali-doped alumina is sodium-doped alumina. In other embodiments, the alkali-doped alumina is a potassium-doped alumina. Alumina co-doped with potassium and sodium is also a suitable solid treatment material. Alumina doped with alkaline earth ions (e.g., one or more of magnesium and calcium) can also be suitable, or alumina doped with a combination of alkali and alkaline earth ions (e.g., sodium- and magnesium-doped alumina).

While the inventors note that zeolites are not required for the claimed processes, in certain embodiments they can be used. Thus, in certain embodiments as otherwise described herein, the solid treatment material is an alkali-doped zeolite, e.g., a sodium-doped zeolite, a potassium-doped zeolite, or a sodium- and potassium-doped zeolite.

In other embodiments, a mesoporous silicate that includes the alkali or alkaline earth metal in ionic form can be used as a support material. The mesoporous silicate can be a mesoporous silica, for example, or can have other constituents, e.g., as a mesoporous aluminosilicate. Examples of support materials include MCM-41, SBA-15, MSU-F and hexagonal mesoporous silicate; these can be doped with the alkali or alkaline earth metal in ionic form using standard procedures.

In certain embodiments as otherwise described herein, the solid treatment material may be an alkali or alkaline earth-containing mineral. For example, in certain embodiments the alkali or alkaline earth-containing mineral is magnesium-containing hydrotalcite.

The alkali- or alkaline earth metal in ionic form is desirably present in a substantial amount. For example, in some embodiments, the amount of alkali or alkaline earth metal in ionic form present in the solid treatment material is an amount of at least 2 wt %, or at least 4 wt %, or at least 6 wt %, or at least 8 wt %, or at least 10 wt %, or at least 15 wt % calculated on atomic basis of the ionic material (i.e., not including any alkali or alkaline earth in metallic form). For example, in certain embodiments, the amount of alkali or alkaline earth metal in ionic form present in the solid treatment material is no more than 35 wt %, e.g., no more than 30 wt %, or no more than 25 wt %. For example, in certain embodiments as otherwise described herein, the amount of alkali or alkaline earth metal in ionic form present in the solid treatment material is in the range of 2-35 wt %, e.g., 4-35 wt %, or 8-35 wt %, or 15-35 wt %, or 2-30 wt %, or 4-30 wt %, or 8-30 wt %, or 10-30 wt %, or 2-25 wt %, or 4-25 wt %, or 6-25 wt %, or 8-25 wt %. Desirably, there is substantially no alkali or alkaline earth in metallic form (e.g., no more than 0.5 wt %, or no more than 0.1 wt %).

The solid treatment material can be provided in a variety of forms, e.g., as a powder, or formed into extrudates or pellets. The person of ordinary skill in the art will appreciate that the contacting of the liquid feed with the solid treatment material can be performed in any desirable fashion, for example, using batch processing or continuous processing. For example, solid treatment material can be added directly to the liquid feed in a reactor, or the liquid feed can be flowed through a bed of the solid treatment material, e.g., in one or more fixed bed reactors. The person of ordinary skill in the art can adapt conventional reactor processes and equipment to perform the processes described herein.

The person of ordinary skill in the art will select a desired treat rate based on the present disclosure. In certain embodiments as otherwise described herein, the amount of solid treatment material present is a range of 0.5-50 wt % of the liquid feed. For example, in some embodiments, the solid treatment material is present in an amount of at least 0.5 wt % of liquid feed, or at least 1 wt % of the liquid feed, or at least 2 wt % of the liquid feed, or at least 4 wt % of the liquid feed. In certain embodiments, the solid treatment material is present in an amount of no more than 40 wt % of the liquid feed, e.g., no more than 30 wt % or no more than 20 wt %. However, the present inventors have determined that in certain embodiments, relatively low amounts of the solid treatment material can be used, e.g., no more than 10 wt %, no more than 8 wt %, or no more than 6 wt %.

In general, the process of the present invention is carried out for a sufficient time to effect a desired degree of removal of chlorinated organics (see below). For example, in certain embodiments, the contacting is performed for at least 10 minutes, or at least 30 minutes, or at least 60 minutes, or at least 90 minutes. For example, in certain embodiments, the contacting is performed for no more than 24 hours, e.g., no more than 12 hours, no more than 8 hours, or no more than 6 hours. In certain embodiments as otherwise described herein, contacting is performed at a time sufficient in the range of 10 minutes to 6 hours.

In general, the process of the present invention is carried out at a process temperature. For example, in certain embodiments, the temperature is at least 80° C., e.g., at least 100° C., or at least 120° C., or at least 160° C., or at least 200° C. For example, in certain embodiments, the temperature is no more than 400° C. or no more than 300° C. In certain embodiments as otherwise described herein, contacting is performed at a temperature in the range of 80-400° C., e.g., in the range of 100-400° C., or 120-400° C., or 160-400° C., or 200-400° C., or 80-300° C., or 100-300° C., or 120-300° C., or 160-300° C., or 200-300° C.

It can in some cases be desirable to regenerate the solid treatment material occasionally to remove contaminants and to empty pores of any collected material. For example, in some embodiments used solid treatment material can be washed with a solvent, e.g., toluene or xylene, or an alcohols such as methanol and ethanol may also be considered. Additionally or alternatively, the solid treatment material can be heated to a temperature sufficient to burn out or drive off organic contaminants. The person of ordinary skill in the art will select conditions sufficient to decontaminate the material without adversely affecting its structure.

Based on the disclosure herein, the amount of chloride-containing organic compounds in the liquid feed after contact with the solid treatment material, i.e. the second chloride concentration, can be selected within a broad range by the person of ordinary skill in the art, based, e.g., on the solid treatment material and reaction conditions used. For example, in certain embodiments, the second chloride concentration is no more than 10 ppmw, or no more than 7 ppmw, or no more than 5 ppmw, or no more than 3 ppmw, or no more than 2 ppmw. However, the inventors note that removal of all of the chlorinated organic is not always necessary, and in many cases it will be desirable to strike a balance between process efficiency and the amount of chlorinated organic remaining in the treated material. For example, in certain embodiments, the second chloride concentration is at least 0.5 ppmw, or at least 1 ppmw.

The presently disclosed process allows for efficient removal of chloride-containing organic compounds from liquid feeds. For example, in certain embodiments, the second chloride concentration is no more than 70% of the first chloride concentration, e.g., no more than 60% of the first chloride concentration, or no more than 50% of first chloride concentration, or no more than 40% of the first chloride concentration, or no more than 30% of the first chloride concentration, or no more than 20% of the first chloride concentration. But as described above, it is not always necessary (or even desirable from the standpoint of overall process efficiency) to remove all of the chlorinated organics from the feedstock. Thus, in certain embodiments, the second chloride concentration is at least 10% of the first chloride concentration, e.g., at least 15% of the first chloride concentration, or at least 20% of the first chloride concentration, or at least 30% of the first chloride concentration. For example, in certain embodiments, the second chloride concentration is in the range of 10-70% of the first chloride concentration, e.g., in the range of 10-60%, or 10-50%, or 10-40%, or 10-30%, or 20-70%, or 20-60%, or 20-50%, or 30-70%, or 30-60%, or 40-70%.

In certain embodiments of the processes as otherwise described herein, the amount fatty acid chlorides after the treatment is no more than 70% of the amount fatty acid chlorides before the treatment, e.g., no more than 60%, or no more than 50%, or no more than 40%, or no more than 30%, or no more than 20%.

In certain embodiments of the processes as otherwise described herein, the amount chlorinated fatty carboxylic acids (e.g., vicinal dichloro-fatty acids, 2-chloro-fatty acids, vicinal-hydroxy, fluoro-fatty acids) or esters thereof after the treatment is no more than 70% of the amount before the treatment, e.g., no more than 60%, or no more than 50%, or no more than 40%, or no more than 30%, or no more than 20%.

As described above, conventional processing steps for renewable feedstocks can be used in conjunction with the processes described herein. For example, in certain embodiments as otherwise described herein, the process further comprises washing the liquid feed with an aqueous fluid to reduce the amount of water-soluble compounds therein (e.g. before contacting with the solid treatment material). Such washing may be accomplished by any process or method known in the art. Such washing can, e.g., remove water-soluble chlorides such as hydrogen chloride.

In certain embodiments as otherwise described herein, the process further comprises degumming, bleaching, and/or filtering the liquid feed (e.g. before and/or after contacting with the solid treatment material). Such degumming, bleaching, or filtering may be accomplished by any process or method known in the art.

In certain embodiments as otherwise described herein, the process further comprises hydroprocessing the liquid feed (e.g., after contacting with the solid treatment material). Such hydroprocessing may be accomplished by any process or method known in the art. In certain embodiments, the hydroprocessing is performed in combination or in admixture with a petroleum-based feedstock. For example, in certain embodiments the hydroprocessing co-processes a petroleum-based feedstock and the treated liquid feed resulting from the processes described herein. The hydroprocessing can perform any of a number of transformations, for example, hydrocracking, hydrodesulfurization, and olefin saturation. Of course, the dechlorinated liquid feed can be subjected to various other process steps, e.g., fluid catalytic cracking, coking, distillation, to provide useful products such as those in the gasoline range.

A liquid fuel may be made by the process disclosed, e.g., a renewable diesel, a biodiesel or a bio-jet fuel. Accordingly, in certain embodiments a process as described herein further comprises processing the treated liquid feed to a liquid fuel. This can include, for example, the hydroprocessing and/or fluid catalytic cracking steps described above, optionally along with, for example, one or more fractionation steps, and/or addition of one or more fuel additives.

Additional aspects of the disclosure are further described by the following non-limiting Examples.

### EXAMPLES

The Examples that follow are illustrative of specific embodiments of the process of the disclosure, and various uses thereof. They are set forth for explanatory purposes only, and are not to be taken as limiting the scope of the disclosure.

### General Procedure

In the Examples, the removal of chloride-containing organic compounds was tested under the general procedure as follows. A batch reactor consisting of a 250 ml round bottom flask equipped with a reflux condenser was assembled on a heating and stirring mantle. Approximately 75 g of organic chloride-containing test material was added to the clean round bottom flask with a magnetic stir bar. Under constant stirring, the round bottom flask and test material was heated to an initial temperature of 60° C. A solid treatment material (STM) was then added to the oil under constant stirring at 60° C. The amount of solid treatment material varied between 1-5 wt % with respect to the weight of the renewable-oil. This amount is specified in Table 1 as STM Amount. The temperature of the oil was then increased to a process temperature between 120-200° C. and controlled within +/−5° C. using a separate digital temperature controller. The temperature is specified in Table 1. The solid treatment material and oil were contacted at the process temperature under stirring for about 90 minutes. At this point, the apparatus was allowed to cool to room temperature. The solid treatment material was then separated from the renewable-oil by centrifugation at 60° C. for about 1 h. The chloride content of the test material was measured before and after contact with the solid treatment material by a monochromatic wavelength dispersive X-ray fluorescence (MWDXRF) process, as determined by a Clora chlorine analyzer, available from XOS USA. The concentration was determined based on a calibration curved developed with known concentrations of chloride-containing organic compounds spiked in soybean oil.

### Comparative Example 1. Control Experiment Using Pre-Washed Chicken Fat

Prior to the experiment, chicken fat was pre-washed in hot distilled water followed by separation in a separating funnel at 60° C. to remove any inorganic and water-soluble chlorides. The removal process was conducted under the General Procedure except with no solid treatment material added to the pre-washed chicken fat; this experiment serves as a control. The process was conducted at 200° C. for about 90 minutes. The decrease in the amount of chloride-containing organic compounds, measured as described above, was 2.5%.

### Comparative Example 2. Comparative Experiments Using Palm Oil

Experiments were conducted under the General Procedure using palm oil with either no solid treatment material added or bleaching clay (5 wt %) added to the palm oil. In a first pair of experiments, the process was conducted at 200° C. for about 90 minutes. The decrease in the amount of chloride-containing organic compounds, measured as described above, was 2.7% when no solid treatment material was present and 14.9% when bleaching clay was present. In a second pair of experiments, the process was conducted at 120° C. for about 90 minutes. The decrease in the amount of chloride-containing organic compounds, measured as described above, was 0.0% when no solid treatment material was present and 23% when bleaching clay was present.

### Comparative Example 3. Processes Using Nickel-Containing Solid Treatment Material

An experiment was conducted under the General Procedure using palm oil with a commercially available solid treatment material with high nickel content (2 wt %) added thereto. The decrease in the amount of chloride-containing organic compounds, measured as described above, was 44.6% when the high-nickel solid treatment material was present.

### Example 1. Organic Chloride Treatment Process from Pre-Washed Chicken Fat with Solid Treatment Materials

An experiment was conducted as in Comparative Example 1 except with the addition of either Mg—Al-hydrotalcite or 8% K/Al₂O₃ as the solid treatment material. These solid treatment materials were added at 5 wt % with respect to the pre-washed chicken fat. The decrease in the amount of chloride-containing organic compounds, measured as described above, was 35.2% when Mg—Al-hydrotalcite was present and 81.8%8% K/Al₂O₃ was present.

### Example 2. Organic Chloride Treatment Process from Palm Oil with Solid Treatment Materials

Experiments were conducted as in Comparative Example 2 at 200° C. except with the addition of either K—X zeolite or 8% K/Al₂O₃ as the solid treatment material. These solid treatment materials were added at 5 wt % with respect to the palm oil. The decrease in the amount of chloride-containing organic compounds, measured as described above, was 54.1% when KX zeolite was present and 77.0% when 8% K/Al₂O₃ was present.

### Example 3. Organic Chloride Treatment Process at Mild Conditions with Solid Treatment Materials

An experiment was conducted as in Comparative Example 2 at 120° C. except with the addition of either Mg—Al-hydrotalcite or 8% K/Al₂O₃ as the solid treatment material. Prewashed chicken fat or palm oil were employed as the renewable-oils. These solid treatment materials were added at 5 wt % with respect to the renewable-oil. The decrease in the amount of chloride-containing organic compounds using Mg—Al-hydrotalcite, measured as described above, was 4.1% for prewashed chicken fat and 7.5% for palm oil. The decrease in the amount of chloride-containing organic compounds using 8% K/Al₂O₃, measured as described above, was 18.9% for palm oil.

### Example 4. Organic Chloride Treatment Process with Solid Treatment Materials of Various Alkali Metal Content

An experiment was conducted as in Comparative Example 2 at 200° C. except with the addition of alumina-based solid treatment materials with differing amounts of potassium or sodium in ionic form. Prewashed used cooking oil (UCO) or palm oil were employed as the test materials. Prior to the experiment, used cooking oil was prewashed in hot distilled water followed by separation in a separating funnel or centrifugation at 60° C. to remove any inorganic and water-soluble chlorides to produce the prewashed UCO. The solid treatment materials used for this example are reported in Table 1. These solid treatment materials were added at 1 wt % or 2 wt % with respect to the test materials. The decrease in the amount of chloride-containing organic compounds for each experiment, measured as described above, is reported in Table 1.

### Example 5. Organic Chloride Treatment Process at Mild Conditions

An experiment was conducted as in Comparative Example 2 except with the addition of 8% K/Al₂O₃ as the solid treatment material. Prewashed UCO or palm oil were employed as the test material. These solid treatment materials were added at 1 or 2 wt % with respect to the test material. The process was conducted at either 160° C. or 120° C. The decrease in the amount of chloride-containing organic compounds at 120° C., measured as described above, was 17.6% for palm oil and 10.8% for UCO. The decrease in the amount of chloride-containing organic compounds in palm oil at 160° C., measured as described above, was 47.3%.

TABLE 1
Summary of Removal Process Conditions and Results

| | | | | STM | Initial | | Final | | Chloride |
|---|---|---|---|---|---|---|---|---|---|
| Example | STM | Feedstock | Temp. | Amount | Chloride | | Chloride | | removed |
| Compar. | None | Pre- | 200° C. | 0 wt % | 15.9 | ppmw | 15.5 | ppmw | 2.5% |
| Ex. 1-1 | | washed | | | | | | | |
| | | Chicken | | | | | | | |
| | | Fat | | | | | | | |
| Compar. | None | Palm Oil | 200° C. | 0 wt % | 7.4 | ppmw | 7.2 | ppmw | 2.7% |
| Ex. 2-1 | | | | | | | | | |
| Compar. | Bleaching | Palm Oil | 200° C. | 5 wt % | 7.4 | ppmw | 6.3 | ppmw | 14.9% |
| Ex. 2-2 | Clay | | | | | | | | |
| Compar. | None | Palm Oil | 120° C. | 0 wt % | 7.4 | ppmw | 7.4 | ppmw | 0.0% |
| Ex. 2-3 | | | | | | | | | |
| Compar. | Bleaching | Palm Oil | 120° C. | 5 wt % | 7.4 | ppmw | 5.7 | ppmw | 23.0% |
| Ex. 2-4 | clay | | | | | | | | |
| Compar. | Commercially | Palm Oil | 200° C. | 2 wt % | 7.4 | ppmw | 4.1 | ppmw | 44.6% |
| Ex. 3-1 | available | | | | | | | | |
| | High Ni | | | | | | | | |
| Ex. 1-1 | Mg—Al- | Pre- | 200° C. | 5 wt % | 15.9 | ppmw | 10.3 | ppmw | 35.2% |
| | Hydrotalcite | Washed | | | | | | | |
| | | Chicken | | | | | | | |
| | | Fat | | | | | | | |
| Ex. 1-2 | 8% K/Al₂O₃ | Pre- | 200° C. | 5 wt % | 15.9 | ppmw | 2.9 | ppmw | 81.8% |
| | | Washed | | | | | | | |
| | | Chicken | | | | | | | |
| | | Fat | | | | | | | |
| Ex. 1-3 | Al₂O₃ | Pre- | 200° C. | 1 wt % | 16.4 | ppmw | 14.4 | ppmw | 12.2% |
| | | Washed | | | | | | | |
| | | Chicken | | | | | | | |
| | | Fat | | | | | | | |
| Ex. 1-4 | 8% K/Al₂O₃ | Pre- | 200° C. | 1 wt % | 16.4 | ppmw | 5.2 | ppmw | 68.2% |
| | | Washed | | | | | | | |
| | | Chicken | | | | | | | |
| | | Fat | | | | | | | |
| Ex. 2-1 | K-X-Zeolite | Palm Oil | 200° C. | 5 wt % | 7.4 | ppmw | 3.4 | ppmw | 54.1% |
| Ex. 2-2 | 8% K/Al₂O₃ | Palm oil | 200° C. | 5 wt % | 7.4 | ppmw | 1.7 | ppmw | 77.0% |
| Ex. 3-1 | Mg—Al- | Palm Oil | 120° C. | 5 wt % | 7.4 | ppmw | 7.1 | ppmw | 4.1% |
| | Hydrotalcite | | | | | | | | |
| Ex. 3-2 | Mg—Al- | Pre- | 120° C. | 5 wt % | 15.9 | ppmw | 14.7 | ppmw | 7.5% |
| | Hydrotalcite | washed | | | | | | | |
| | | Chicken | | | | | | | |
| | | Fat | | | | | | | |
| Ex. 3-3 | 8% K/Al₂O₃ | Palm Oil | 120° C. | 5 wt % | 7.4 | ppmw | 6 | ppmw | 18.9% |
| Ex. 4-1 | 8% K/Al₂O₃ | Palm Oil | 200° C. | 2 wt % | 7.4 | ppmw | 1.5 | ppmw | 79.7% |
| Ex. 4-2 | 8% K/Al₂O₃ | Palm Oil | 200° C. | 1 wt % | 7.4 | ppmw | 1.6 | ppmw | 78.4% |
| Ex. 4-3 | 8% K/Al₂O₃ | Pre- | 200° C. | 1 wt % | 12.9 | ppmw | 5.6 | ppmw | 56.5% |
| | | washed | | | | | | | |
| | | UCO | | | | | | | |
| Ex. 4-4 | Al₂O₃ | Pre- | 200° C. | 1 wt % | 12.9 | ppmw | 10.5 | ppmw | 18.9% |
| | | washed | | | | | | | |
| | | UCO | | | | | | | |
| Ex. 4-5 | 15% K/Al₂O₃ | Palm Oil | 200° C. | 2 wt % | 7.4 | ppmw | 1.7 | ppmw | 77.0% |
| Ex. 4-6 | 20% K/Al₂O₃ | Palm Oil | 200° C. | 2 wt % | 7.4 | ppmw | 2.4 | ppmw | 67.6% |
| Ex. 4-7 | Commercially | Palm Oil | 200° C. | 2 wt % | 7.4 | ppmw | 2.2 | ppmw | 70.3% |
| | available ~12% | | | | | | | | |
| | Na/Al₂O₃ | | | | | | | | |
| Ex. 4-8 | 20% | Palm Oil | 200° C. | 2 wt % | 7.4 | ppmw | 5 | ppmw | 32.4% |
| | Na/Al₂O₃ | | | | | | | | |
| Ex. 4-9 | 20% | Palm Oil | 200° C. | 2 wt % | 7.4 | ppmw | 5.6 | ppmw | 24.3% |
| | Mg/Al₂O₃ | | | | | | | | |
| Ex. 5-1 | 8% K/Al₂O₃ | Palm Oil | 160° C. | 2 wt % | 7.4 | ppmw | 3.9 | ppmw | 47.3% |
| Ex. 5-2 | 8% K/Al₂O₃ | Palm Oil | 120° C. | 1 wt % | 7.4 | ppmw | 6.1 | ppmw | 17.6% |
| Ex. 5-3 | 8% K/Al₂O₃ | Pre- | 120° C. | 1 wt % | 12 | ppmw | 10.7 | ppmw | 10.8% |
| | | washed | | | | | | | |
| | | UCO | | | | | | | |

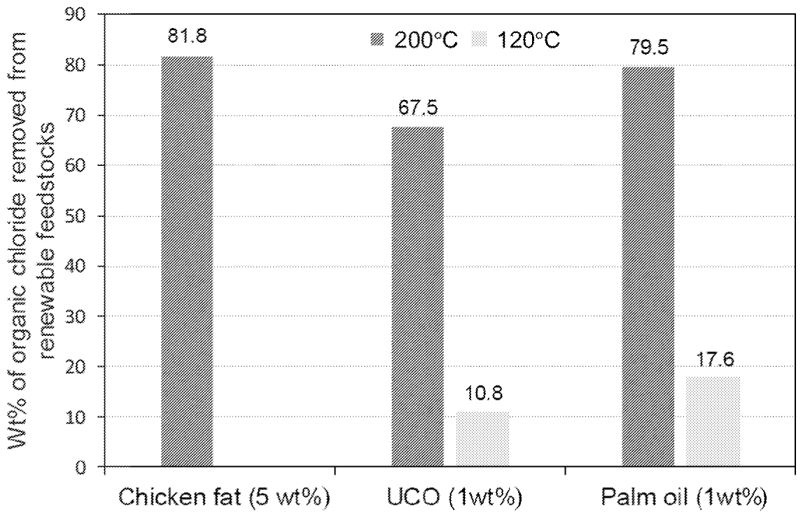

Representative results from Table 1 are summarized in FIG. 1. Accordingly, utilizing solid treatment materials that contain alkali metal or alkaline earth metals in ionic form exhibit better performance over the comparative examples for removing chloride-containing organic compounds from the various renewable-oils tested. The best performance observed utilized 8 wt % K/Al₂O₃. With 8 wt % K/Al₂O₃, the amount of chloride-containing organic compounds removed was over 80% from chicken fat, about 80% from palm oil, and about 70% from pre-washed UCO at 200° C. process temperature. From the results reported in Table 1, the process disclosed removed chloride-containing organics from palm oil from an initial chloride concentration of about 7.4 ppmw to below 2 ppmw, from chicken fat from about 16 ppmw to below 3 ppmw, and from UCO from about 12 ppmw to below 4 ppmw. Similar, albeit slightly lower, efficacy was observed for Na/Al₂O₃. Surprisingly, un-doped alumina (Ex. 4-4), with no alkali metal or alkaline earth metal, was relatively ineffective for organic chloride removal, pointing to the importance of alkali metal and alkaline earth metals. These results meet the desired target range for chloride-containing organic compounds in order to process these renewable feedstock in refinery units safely, efficiently, and reliably without significant corrosion and fouling risk.

The processes described herein can be useful in a variety of industries. For example, as described above, the processes described herein can be useful in converting bio- and renewable feedstocks (optionally in admixture with materials sourced from petroleum feeds) to useful fuels. Removal of organic chlorides can help reduce damage in downstream processes such as hydroprocessing and fluid catalytic cracking as described above, as well as in other refinery processes such as distillation and coking. The processes described herein can also be useful in the food industry, where certain organic chlorides are known to be carcinogenic. And in virtually any industry, damage of equipment by hydrochloric acid generated from organic chlorides can be a significant concern.

The particulars shown herein are by way of example and for purposes of illustrative discussion of certain embodiments of the present disclosure only and are presented in the cause of providing what is believed to be the most useful and readily understood description of the principles and conceptual aspects of various embodiments of the disclosure. In this regard, no attempt is made to show details associated with the processes of the disclosure in more detail than is necessary for the fundamental understanding of the processes described herein, the description taken with the examples making apparent to those skilled in the art how the several forms of the processes of the disclosure may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the processes of the disclosure (especially in the context of the following embodiments and embodiments) are to be construed to cover both the singular and the plural, unless otherwise indicated herein or clearly contradicted by context.

All processes described herein can be performed in any suitable order of steps unless otherwise indicated herein or otherwise clearly contradicted by context. The use of any and all examples, or exemplary language (e.g., “such as”) provided herein is intended merely to better illuminate the processes of the disclosure and does not pose a limitation on the scope of the disclosure. No language in the specification should be construed as indicating any non-embodied element essential to the practice of the processes of the disclosure.

Unless the context clearly requires otherwise, throughout the description and the embodiments, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure are not to be construed as limitations. Each group member may be referred to and embodied individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Some embodiments of various aspects of the disclosure are described herein, including the best mode known to the inventors for carrying out the processes described herein. Of course, variations on these described embodiments will become apparent to those of ordinary skill in the art upon reading the foregoing description. The skilled artisan will employ such variations as appropriate, and as such the processes of the disclosure can be practiced otherwise than specifically described herein. Accordingly, the scope of the disclosure includes all modifications and equivalents of the subject matter recited in the embodiments appended hereto as permitted by applicable law. Moreover, any combination of the above-described elements in all possible variations thereof is encompassed by the disclosure unless otherwise indicated herein or otherwise clearly contradicted by context.

Accordingly, various aspects and embodiments of the disclosure are provided by the following enumerated embodiments, which can be combined in any number and in any combination that is not technically or logically inconsistent.

Embodiment 1. A process for processing a liquid feed, the process comprising:
providing a liquid feed that comprises one or more fatty acids and/or fatty acid esters, the liquid feed having a first chloride concentration by weight of chloride-containing organic compounds; and
contacting the liquid feed with a solid treatment material to remove at least a fraction of the chloride-containing organic compounds to produce a treated liquid feed having a second chloride concentration that is less than the first chloride concentration,
wherein the solid treatment material comprises an alkali metal or an alkaline earth metal in ionic form.

Embodiment 2. The process of embodiment 1, wherein the liquid feed comprises a renewable feedstock, e.g., comprises renewable as the only feedstock.

Embodiment 3. The process of embodiment 1, wherein the liquid feed includes at least 70 wt % renewable feedstock, e.g., at least 80 wt %, or at least 90 wt %.

Embodiment 4. The process of any of embodiments 1-3, wherein the liquid feed further includes a feedstock derived from crude oil.

Embodiment 5. The process of any of embodiments 1-4, wherein the liquid feed comprises one or more fats, oils or greases.

Embodiment 6. The process of embodiment 5, wherein the liquid feed comprises one or more animal fats, for example, chicken fat, beef fat, pork fat, sheep fat or fish oil, e.g., in the form of choice white grease or inedible tallow).

Embodiment 7. The process of embodiment 5 or embodiment 6, wherein the liquid feed comprises one or more vegetable oils, for example, corn oil, rapeseed (canola) oil, sunflower oil, soybean oil, cotton seed oil, nettlespurge oil, coconut oil, or palm oil.

Embodiment 8. The process of any of embodiments 1-7, wherein the liquid feed comprises used, recycled or waste fats, oils or greases, e.g., used cooking oil.

Embodiment 9. The process of any of embodiments 1-8, wherein the liquid feed includes at least 25 wt % fatty acids and/or fatty acid esters, e.g., at least 35 wt %.

Embodiment 10. The process of any of embodiments 1-8, wherein the liquid feed includes at least 40 wt % fatty acids and/or fatty acid esters, e.g., at least 60 wt %.

Embodiment 11. The process of any of embodiments 1-8, wherein the liquid feed includes at least 70 wt % fatty acids and/or fatty acid esters, e.g., at least 80 wt %, or at least 90 wt %.

Embodiment 12. The process of any of embodiments 1-11, wherein the ratio of fatty acids to fatty acid esters in the liquid feed is in the range of 0:1 to 1:1, e.g., from 0:1 to 1:0.5, or from 0:1 to 1:0.2, or from 0:1 to 1:0.1, or 0:1 to 1:0.05.

Embodiment 13. The process of any of embodiments 1-12, wherein the fatty acid esters comprise one or more of fatty acid triglycerides, fatty acid diglycerides, fatty acid monoglycerides, and fatty acid alkyl esters (e.g., fatty acid methyl ester, fatty acid ethyl ester).

Embodiment 14. The process of any of embodiments 1-13, wherein the chloride-containing organic compounds are selected from the group consisting of chlorine-substituted long-chain (C10+) paraffins, long-chain acid chlorides, chlorine-substituted long-chain aldehydes, chlorine-substituted long-chain ketones, cholesterol-like organic chlorides, and short-chain (C2-C9) diols such as 3-monochloropropane-1,2-diol or 2-monochloropropane-1,3-diol.

Embodiment 15. The process of any of embodiments 1-14, wherein the first chloride concentration is at least 2 ppmw, e.g., at least 5 ppmw.

Embodiment 16. The process of any of embodiments 1-14, wherein the first chloride concentration is at least 7 ppmw, e.g., at least 10 ppmw.

Embodiment 17. The process of any of embodiments 1-14, wherein the first chloride concentration is at least 15 ppmw.

Embodiment 18. The process of any of embodiments 1-17 wherein the first chloride concentration is no more than 300 ppmw, e.g., no more than 250 ppmw.

Embodiment 19. The process of any of embodiments 1-17, wherein the first chloride concentration is no more than 100 ppmw, e.g., no more than 75 ppmw.

Embodiment 20. The process of any of embodiments 1-14, wherein the first chloride concentration is in the range of 2-300 ppmw, e.g., 5-300 ppmw, or 10-300 ppmw, or 2-100 ppmw, or 5-100 ppmw, or 10-100 ppmw.

Embodiment 21. The process of any of embodiments 1-20, wherein the solid treatment material comprises the alkali metal in ionic form.

Embodiment 22. The process of embodiment 21, wherein the solid treatment material comprises sodium ions, potassium ions, or a combination thereof.

Embodiment 23. The process of any of embodiments 1-22, wherein the solid treatment material comprises the alkaline earth metal in ionic form.

Embodiment 24. The process of any of embodiments 1-23, wherein the solid treatment material comprises alkali or alkaline earth ions disposed on a support.

Embodiment 25. The process of embodiment 24, wherein the support is alumina.

Embodiment 26. The process of embodiment 24, wherein the support is an aluminosilicate or a silicate, e.g., a mesoporous silicate or aluminosilicate.

Embodiment 27. The process of embodiment 24, wherein the solid treatment material is not a microporous zeolite.

Embodiment 28. The process of any of embodiments 1-20, wherein the solid treatment material is an alkali-doped alumina.

Embodiment 29. The process of any of embodiments 1-20, wherein the solid treatment material is a sodium-doped alumina.

Embodiment 30. The process of any of embodiments 1-20, wherein the solid treatment material is a potassium-doped alumina.

Embodiment 31 The process of any of embodiments 1-20, wherein the solid treatment material is a sodium- and potassium-doped alumina.

Embodiment 32. The process of any of embodiments 1-20, wherein the solid treatment material is a sodium- and potassium-doped zeolite.

Embodiment 33. The process of any of embodiments 1-20, wherein the solid treatment material comprises an alkali or alkaline earth-containing mineral.

Embodiment 34. The process of embodiment 33, wherein the solid treatment material is a magnesium-containing hydrotalcite.

Embodiment 35. The process of any of embodiments 1-34, wherein the alkali or alkaline earth is present in the solid treatment material in an amount of at least 2 wt %, e.g., at least 4 wt %.

Embodiment 36. The process of any of embodiments 1-34, wherein the alkali or alkaline earth is present the solid treatment material in an amount of at least 6 wt %, e.g., at least 8 wt %.

Embodiment 37. The process of any of embodiments 1-34, wherein the alkali or alkaline earth is present in the solid treatment material an amount of at least 10 wt %, e.g., at least 15 wt %.

Embodiment 38. The process of any of embodiments 1-37, wherein the alkali or alkaline earth is present in the solid treatment material an amount of no more than 35 wt %, e.g., no more than 30 wt % or no more than 25 wt %.

Embodiment 39. The process of any of embodiments 1-38, wherein the solid treatment material is present in an amount of at least 0.5 wt % of the liquid feed, e.g., at least 1 wt %, or at least 2 wt %, or at least 4 wt %.

Embodiment 40. The process of any of embodiments 1-39, wherein the contacting is performed for a time of at least 10 minutes, e.g., at least 30 minutes.

Embodiment 41. The process of any of embodiments 1-39, wherein the contacting is performed for a time of at least 60 minutes, e.g., at least 90 minutes.

Embodiment 42. The process of any of embodiments 1-41, wherein the contacting is performed for a time of no more than 24 hours, e.g., no more than 12 hours, no more than 8 hours, or no more than 6 hours.

Embodiment 43. The process of any of embodiments 1-42, wherein the contacting is performed at temperature of at least 80° C., e.g., at least 100° C.

Embodiment 44. The process of any of embodiments 1-42, wherein the contacting is performed at a temperature of at least 120° C., e.g., at least 160° C.

Embodiment 45. The process of any of embodiments 1-44, wherein the contacting is performed at a temperature of at least 200° C.

Embodiment 46. The process of any of embodiments 1-45, wherein the contacting is performed at a temperature of no more than 400° C., e.g., no more than 300° C.

Embodiment 47. The process of any of embodiments 1-46, wherein the process is performed for a time and under conditions such that the second chloride concentration is no more than 10 ppmw, e.g., no more than 7 ppmw.

Embodiment 48. The process of any of embodiments 1-46, wherein the process is performed for a time and under conditions such that the second chloride concentration is no more than 5 ppmw, e.g., no more than 3 ppmw.

Embodiment 49. The process of any of embodiments 1-46, wherein the process is performed for a time and under conditions such that the second chloride concentration is no more than 2 ppmw.

Embodiment 50. The process of any of embodiments 47-49, wherein the second chloride concentration is at least 0.5 ppmw, e.g., at least 1 ppmw.

Embodiment 51. The process of any of embodiments 1-50, wherein the process is performed for a time and under conditions such that the second chloride concentration is no more than 70% of the first chloride concentration, e.g., no more than 60%

Embodiment 52. The process of any of embodiments 1-50, wherein the process is performed for a time and under conditions such that the second chloride concentration is no more than 50% of the first chloride concentration, e.g., no more than 40%.

Embodiment 53. The process of any of embodiments 1-50, wherein the process is performed for a time and under conditions such that the second chloride concentration is no more than 30% of the first chloride concentration, e.g., no more than 20%.

Embodiment 54. The process of any of embodiments 51-53, wherein the second chloride concentration is at least 10% of the first chloride concentration, e.g., at least 15% of the first chloride concentration.

Embodiment 55. The process of any of embodiments 51-53, wherein the second chloride concentration is at least 20% of the first chloride concentration, e.g., at least 30% of the first chloride concentration.

Embodiment 56. The process of any of embodiments 1-55, further comprising washing the liquid feed with an aqueous fluid to reduce amounts of water-soluble compounds therein, e.g., before contacting with the solid treatment material.

Embodiment 57. The process of any of embodiments 1-56, further comprising degumming, bleaching, and/or filtering the liquid feed, e.g., before and/or after contacting with the solid treatment material.

Embodiment 58. The process of any of embodiments 1-57, further comprising hydroprocessing the liquid feed, e.g., after contacting with the solid treatment material.

Embodiment 59. The process of embodiment 58, wherein the hydroprocessing is performed in mixture with a petroleum-based feedstock.

Embodiment 60. A liquid fuel made by the process of any of any of embodiments 1-59, e.g., a diesel, a jet fuel or a gasoline such as a renewable diesel, a biodiesel, a bio-jet fuel or a bio-gasoline.

In closing, it is to be understood that the various embodiments herein are illustrative of the processes of the disclosures. Other modifications that may be employed are within the scope of the disclosure. Thus, by way of example, but not of limitation, alternative configurations of the processes may be utilized in accordance with the teachings herein. Accordingly, the processes of the present disclosure are not limited to that precisely as shown and described.

1. A process for processing a liquid feed, the process comprising:
providing a liquid feed that comprises one or more fatty acids and/or fatty acid esters, the liquid feed having a first chloride concentration by weight of chloride-containing organic compounds; and
contacting the liquid feed with a solid treatment material to remove at least a fraction of the chloride-containing organic compounds to produce a treated liquid feed having a second chloride concentration that is less than the first chloride concentration,
wherein the solid treatment material comprises potassium in ionic form in an amount of at least 2 wt %, based on the weight of the solid treatment material.

2. The process of claim 1, wherein the liquid feed includes at least 70 wt % renewable feedstock.

3. The process of claim 1, wherein the liquid feed includes at least 70 wt % fatty acids and/or fatty acid esters.

4. The process of claim 1, wherein the ratio of fatty acids to fatty acid esters in the liquid feed is in the range of 0:1 to 1:1.

5. The process of claim 1, wherein the fatty acid esters comprise one or more of fatty acid triglycerides, fatty acid diglycerides, fatty acid monoglycerides, and fatty acid alkyl esters.

6. The process of claim 1, wherein the chloride-containing organic compounds are selected from the group consisting of chlorine-substituted long-chain (C10+) paraffins, long-chain acid chlorides, chlorine-substituted long-chain aldehydes, chlorine-substituted long-chain ketones, cholesterol-like organic chlorides, and short-chain (C2-C9) diols such as 3-monochloropropane-1,2-diol or 2-monochloropropane-1,3-diol.

7. The process of claim 1, wherein the first chloride concentration is at least 15 ppmw.

8. The process of claim 1 wherein the first chloride concentration is no more than 300 ppmw.

9. (canceled)

10. The process of claim 1, wherein the solid treatment material comprises potassium in ionic form disposed on a support.

11. The process of claim 10, wherein the support is alumina, an an aluminosilicate or a silicate.

12. The process of claim 10, wherein the solid treatment material is not a microporous zeolite.

13. The process of claim 1, wherein the solid treatment material is a potassium-doped alumina.

14. The process of claim 1, wherein the solid treatment material is a potassium-doped zeolite.

15. The process of claim 1, wherein the solid treatment material comprises a potassium-containing mineral.

16. (canceled)

17. The process of claim 1, wherein the solid treatment material is present in an amount of at least 0.5 wt % of the liquid feed.

18. The process of claim 1, wherein the contacting is performed for a time of at least 10 minutes.

19. The process of claim 1, wherein the contacting is performed at temperature of at least 80° C.

20. The process of claim 1, wherein the process is performed for a time and under conditions such that the second chloride concentration is no more than 5 ppmw.

21. The process of claim 1, wherein the process is performed for a time and under conditions such that the second chloride concentration is no more than 50% of the first chloride concentration.

22. The process of claim 1, further comprising washing the liquid feed with an aqueous fluid to reduce amounts of water-soluble compounds therein.

23. The process of claim 1, further comprising hydroprocessing the liquid feed.
